(19) United States
(12) Patent Application Publication
(10) Pub. No.: US 2009/0271287 A1
(43) Pub. Date: Oct. 29, 2009

(54) FINANCIAL LIFESTYLE NAVIGATOR AND BANKING SYSTEM

(75) Inventor: Lisa HALPERN, Amagnsett, NY (US)

Correspondence Address: ARENT FOX LLP, 1050 CONNECTICUT AVENUE, N.W., SUITE 400, WASHINGTON, DC, 20036, US

(73) Assignee: KIBOO LICENSING, LLC a Delaware limited liability company, Amagnsett, NY (US)

(21) Appl. No.: 12/429,657

(22) Filed: Apr. 24, 2009

Related U.S. Application Data
(60) Provisional application No. 61/047,587, filed on Apr. 24, 2008.
(60) Provisional application No. 61/142,748, filed on Jan. 6, 2009.
(60) Provisional application No. 61/148,082, filed on Jan. 29, 2009.
(60) Provisional application No. 61/202,838, filed on Apr. 10, 2009.

(51) Int. Cl. G06Q 40/00; G06Q 30/00

(52) U.S. Cl. 705/26; 705/35; 705/39

(57) ABSTRACT

Methods and systems for electronic financial management integrate many aspects of the typical banking system with exciting educational and social tools to engage users to participate in and learn about the value of fiscal management. A web application for a network site may be employed to allow users to establish accounts. Joint accounts may be established for teens or other users without the capacity or experience to independently manage money, providing custodians control over the joint account and opportunities to interactively engage the user via effective fiscal management tools. Aspects of the methods and systems for financial management may provide interactive opportunities for users to, for example, manage money, set goals, track finances, pay bills, shop savvy, solicit advice from friends and family, and obtain answers to financial questions. Web applications may provide users mobile and on line access to financial information, financial management tools, and vendor products and services.

This application claims the benefit of U.S. Provisional Application No. 61/047,587 titled BANKING SYSTEM AND METHODS, filed Apr. 24, 2008, U.S. Provisional Application No. 61/142,748 titled BANKING SYSTEM AND METHODS, filed Jan. 6, 2009, U.S. Provisional Application No. 61/146,082 titled BANKING SYSTEM AND METHODS, filed Jan. 21, 2009, and U.S. Provisional Application No. 61/202,838 titled FINANCIAL LIFESTYLE NAVIGATOR AND BANKING SYSTEM, filed Apr. 10, 2009. The entirety of each of these patent applications is incorporated herein by reference.

### BACKGROUND OF THE INVENTION

1. Field of the Invention

Aspects of the present invention relate to the field of financial management and, in particular, to methods and systems for providing interactive and web-based financial management and banking.

2. Background of the Technology

For many people, their first experience with a bank is as a teen opening and maintaining a savings account. This experience generally involves a trip to a bank with a parent or guardian, setting up an account under their auspices, and making a small deposit with some birthday money or saved up allowance. Beyond that exciting initial experience, banking for a teen typically devolves into the occasional deposit and possibly tracking of a trickle of interest through monthly or quarterly statements.

Banks, naturally, do not gear their marketing, products or services toward teens. As such, parents and guardians are often left to teach the many lessons of fiscal management and responsibility, without access to any constructive tools. In particular, today's banking systems are not structured to interactively and proactively engage the teens themselves in the education process, and it is a well known concept in human development that humans learn best by doing. This is especially true for teens.

Among other things, the related art lacks systems and methods that effectively integrate the many aspects of a banking system with an array of exciting tools and features in such a manner so that teens and, in particular, teenagers and young adults, can actively participate in learning the fundamentals of money and fiscal management through banking. Additionally, among other things, related art systems and methods do not provide tools that allow parents, guardians, or other interested parties to actively and concurrently participate in a teen's banking experience.

### SUMMARY OF THE INVENTION

The following presents a simplified summary of one or more aspects of the present invention in order to provide a basic understanding of such aspects. This summary is not an extensive overview of all contemplated aspects, and is intended to neither identify key or critical elements of all aspects nor delineate the scope of any or all aspects. Its intent is to present some concepts of one or more aspects in a simplified form as a prelude to the more detailed description that is presented later.

Aspects of the present invention overcome the above identified problems of the related art, as well as others, by providing methods and systems for financial management and banking geared toward teens and/or other users needing account supervision. Variations in accordance with aspects of the invention effectively integrate the many aspects of a typical banking system with exciting educational and social tools, among other things, in order to engage users, in participating in banking and learning about the value of money and fiscal management. Methods and systems in accordance with aspects of the present invention provide fun and easy ways to create and manage interactive bank accounts. These custodial accounts can be set up by teens under the age of eighteen (18) with their parent, grandparent, guardian or other custodial figure co-signing (such persons also interchangeably referred to herein as “a custodian” or a “parent”). A variety of accounts can be established, including, among others, hybrid savings/money market accounts, certificate of deposit accounts, trust accounts and investment accounts. Many of the typical banking services may be offered to these account holders, including on-line banking and bill-pay, as well as obtaining and managing accounts for credit cards, checking/debit cards, pre-paid bank cards, gift cards, and loans (e.g., for car, student, or family). The banking services can be set up so that the custodian has co-signing authority, unless that authority is waived, for example. Direct deposit can be established for family members or other interested individuals that want to make deposits for allowance, personal achievements, such as good grades, or for just about any other purpose, including birthdays or holidays.

Aspects of the present invention include employing a web application for a network site (e.g., an Internet Web site) as one avenue for combining exciting features and learning tools with a financial management and banking system. Among other things, the web application allows users to initially establish accounts and provides account holders with numerous options for customizing the experience of the network. Besides providing a mechanism for managing bank accounts, the Web site creates exciting interactive opportunities for users, including, but not limited to, teenagers or others without the capacity or experience to independently manage money (such users also interchangeably referred to herein as a “user” or a “teen”), to learn about the value of money and fiscal management and responsibility. Social networking features may allow a user to set goals, for example, of which family and friends may be informed, so as to contribute toward achievement. Access to money experts may be available to further increase a user's ability to learn and manage financial goals and objectives.

Another aspect of the present invention includes a mobile application developed for a portable electronic device, such as a mobile telephone or personal digital assistant (PDA), for example, that lets users manage their money, set goals, track finances and progress, pay bills, learn financial literacy, shop savvy, solicit advice from friends and family, and obtain answers to financial questions 24 hours a day, seven days a week.

Additional advantages and novel features of aspects of the invention, including the combination of the on-line application with the mobile application into a broad system application of various features in accordance with aspects of the present invention, is set forth in part in the description that follows, and in part will become more apparent to those skilled in the art upon examination of the following or upon learning by practice thereof.

### BRIEF DESCRIPTION OF THE FIGURES

In the drawings:

FIG. 1 depicts an exemplary system diagram of various hardware components and other features, in accordance with aspects of the present invention;

FIG. 2 illustrates a high-level block diagram of various system components, in accordance with aspects of the present invention;

FIG. 3 is an exemplary wireframe diagram of a landing page, in accordance with aspects of the present invention;

FIG. 4 is a flowchart depicting an account creation process and related features, in accordance with aspects of the present invention;

FIG. 5 shows an exemplary flow diagram of various functions performed in creating an account and using a banking system, in accordance with aspects of the present invention;

FIG. 6 is an exemplary wireframe diagram of a personal web page for a user, in accordance with aspects of the present invention;

FIG. 7 is an exemplary wireframe diagram of a parental web page, in accordance with aspects of the present invention;

FIGS. 8A-8C are flowcharts depicting exemplary balance management processes, in accordance with aspects of the present invention;

FIG. 9 is an exemplary wireframe diagram of a web page for adding a personal financial goal, in accordance with aspects of the present invention;

FIG. 10 is an exemplary wireframe diagram of a web page showing illustrating savings information for a user, in accordance with aspects of the present invention;

FIG. 11 illustrates an exemplary process flow for a third party transfer of funds in which the third party is an existing account holder or wishes to create a “transfer user” account, in accordance with aspects of the present invention;

FIG. 12 illustrates an exemplary process flow for a third party transfer of funds in which the third party does not wish to create an account or independently seeks to contribute money, in accordance with aspects of the present invention;

FIG. 13 illustrates an exemplary process flow for a purchasing an item identified as a goal from a preferred vendor, in accordance with aspects of the present invention;

FIG. 14 shows an exemplary flow chart for the receipt delivery process, in accordance with aspects of the present invention;

FIG. 15 shows an exemplary flow chart for a cash deposit process, in accordance with aspects of the present invention;

FIG. 16 shows an exemplary flow chart for a check depositing process, in accordance with aspects of the present invention;

FIG. 17 illustrates an exemplary flow chart for the flow of spending information, in accordance with aspects of the present invention;

FIG. 18 shows an exemplary flow chart for the cash back incentive process, in accordance with aspects of the present invention; and

FIGS. 19A-19D show renderings of the mobile application as employed on a mobile device, in accordance with aspects of the present invention.

### DETAILED DESCRIPTION

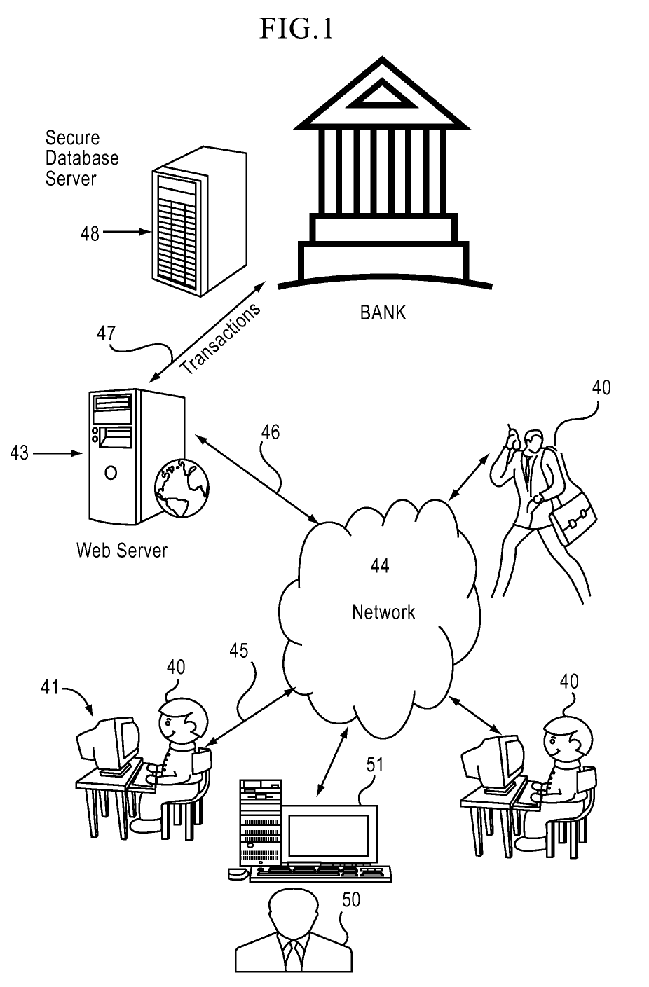

In accordance with aspects of the present invention, parents, relatives, or other custodial figures, among others, may work integrally with a user to establish an account. This function may be performed, for example, by accessing the system's Web site through an Internet connection and establishing an account. FIG. 1 shows an exemplary system diagram for a banking system usable in accordance with aspects of the present invention. In this exemplary variation, custodial accounts can be set up for teens under the age of eighteen (18) with a parent, grandparent, guardian or other custodial figure co-signing, for example. The account, in essence, is thereby controlled and monitored, or otherwise handled, by the custodian. Account creation and maintenance may be performed according to standard banking and privacy rules and practices. These operations may include all of the appropriate internal controls that are required for an Internet banking system, for example, so that the custodians can be assured that all of the personal and financial information will be protected and handled with the highest appropriate safeguards.

Access to the web application and capabilities of the system in accordance with aspects of the present invention may occur via various hardware and access selection options. As shown in FIG. 1, in one illustrative variation of the present invention, for example, a user 40, such as a teenager, can use locally loaded software at the user's terminal 41, such as a personal computer (PC), minicomputer, microcomputer, mainframe computer, telephone device, hand-held device such as a personal digital assistant (PDA), or other wireless device with a processor, display, and capability for connecting to a network 44, such as the Internet. A user 40 can use the terminal 41 to access a web server 43 via couplings 45, 46. Similarly, one or more vendors (50) may be communicatively coupled to the web server 43 via a terminal 51, for example. The server 43 includes, for example, a PC, minicomputer, microcomputer, mainframe computer, or other device having a processor and a repository for data. The server 43 may be connected to a separate repository for data 48, which could be, for example, a secure database server for storing transactional data such as user account information, preferences, and security information. The server 43 may be a host web server or a primary server, and may be situated, for example, at a financial institution (such institution also interchangeably referred to herein as a “bank”) or at any location permitting connectivity to the network as described herein. The server 43 may be securely connected to a banking system that may separately include a bank server and a bank database repository (not shown). The couplings 45, 46, and 47 may include, for example, wired, wireless, or fiberoptic connections.

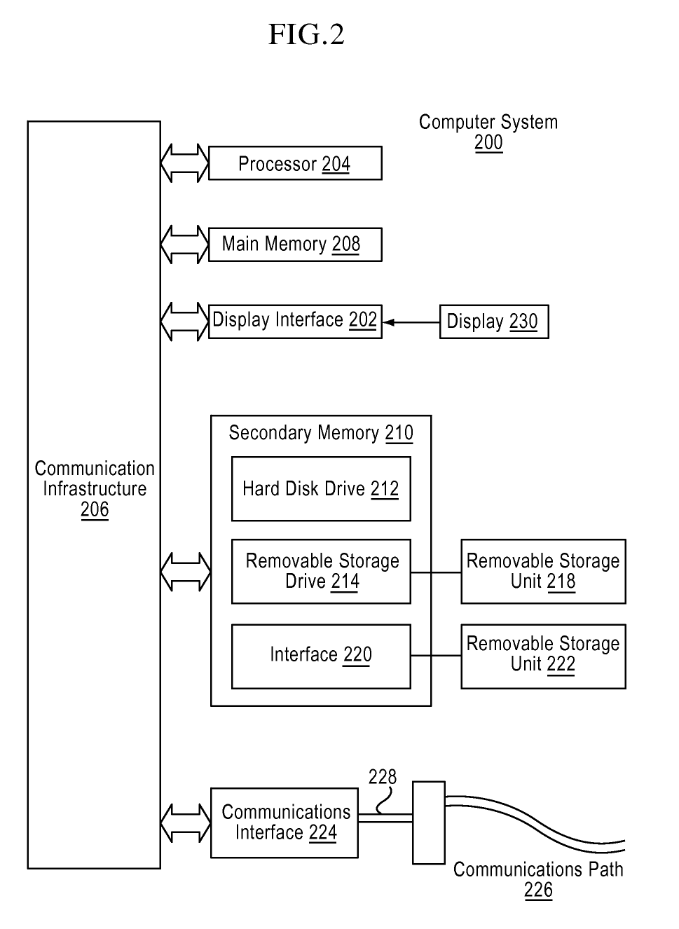

Aspects of the present invention may be implemented using hardware, software or a combination thereof and may be implemented in one or more computer systems or other processing systems. In one variation, aspects of the present invention may be directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software features are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on a display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative variations, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred through communications interface 224 are in the form of signals 228, which may be electronic, electromagnetic, optical or other signals capable of being received by communications interface 224. These signals 228 are provided to communications interface 224 through a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received through communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In variations where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another variation, aspects of the present invention can be implemented primarily in hardware using, for example, hardware components, such as application specific integrated circuits (ASICs). Implementation of the hardware state machine so as to perform the functions described herein will be apparent to persons skilled in the relevant art(s).

Exemplary aspects of the invention as described herein may be referred to in conjunction with the trademark KIBOO™. Aspects of the implementation, as described above, may be in the form of one or more software web applications accessible through a Web site and comprising one or more of the following aspects:

personal web pages available to each user of the financial navigation and banking system (FNBS) available for account maintenance and other personalized actions;

a mobile application for uploading to a portable electronic device and, in particular, for use with iPhone®/iPod Touch® platforms (iPhone®/iPod Touch® are registered trademarks of Apple, Inc. of Cupertino, Calif.);

a mobile browser for use on a mobile device with internet connectivity;

financial literacy resources and information where users can ask questions, take quizzes, use tools and learn about financial aspects in general;

a money expert module for tracking individual account activity and providing personalized feedback that is integrated into the user's experience, in order to reinforce positive financial behavior and provide tips and other information to help users better manage their money; and

corporate web pages that contain information about the Web site.

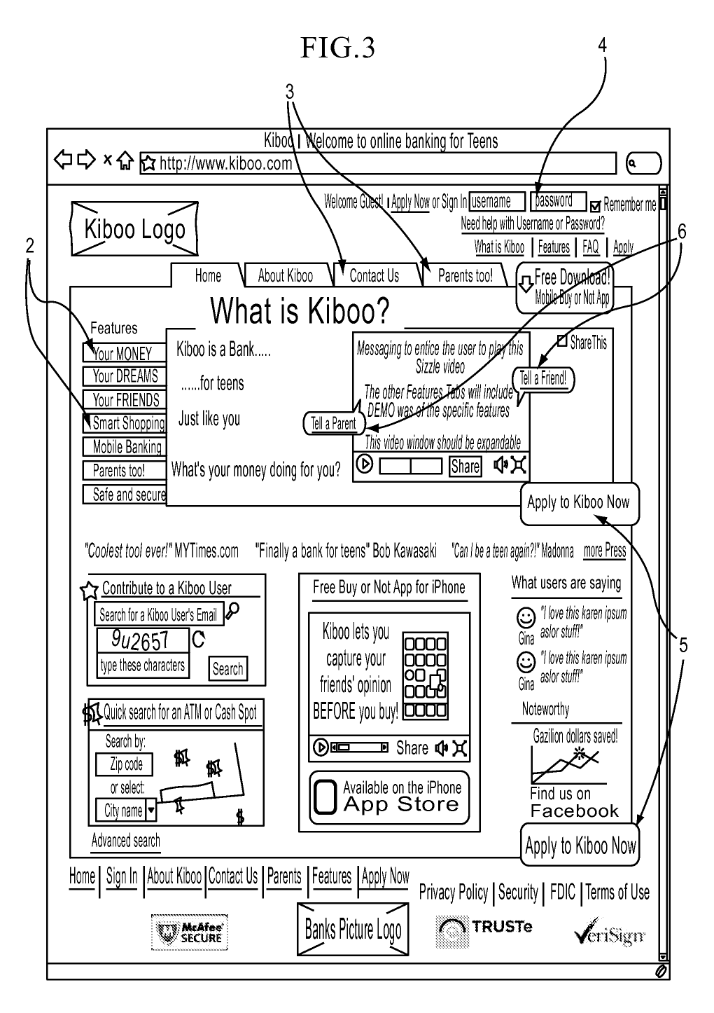

FIG. 3 shows a screenshot of an exemplary landing page in accordance with aspects of the present invention, which may be the first page users see when they enter the site prior to login. Once a user logs in, the user may be taken to a personal home page. As shown in FIG. 3, the landing page may contain general information about the system and links 2 to specific features or demonstrations, for example. Tabs 3 may be provided to gain access to additional information, such as corporate and contact information, or parent specific media. The landing page, for example, may contain a login area 4 for those users with established accounts to enter a user identification (“ID”) and password. There may be application links 5 for new users to apply for an account. Other information may include a registered user search for friends and family to search for a user's account, Automated Teller Machine (ATM) Network locations, cash deposit locations, a featured content/buzz link to the latest and greatest offerings, a link to downloadable mobile applications for use with the system, and links to various pages, such as terms of use, privacy policies, security assurance, frequently asked questions, and retail/promotional partners information.

The landing page may also include a “Tell a Friend” or a “Tell a Parent” service, in which a link/button 6 on the Web application may allow users to invite friends and/or parent to join and/or view the features of the FNBS, for example. In this event, e-mail may be generated and sent to the invitees with a link to a demonstration of the FNBS. A promotional code may be included in the invitation(s) that entitles recipients who open a new account to receive a pre-determined cash deposit into the new account. The FNBS may automatically keep track of the invitees. If an invitee opens a new account through the FNBS by going through the process of creating an account, the user may receive a referral reward, for example. Although described above with reference to certain exemplary features, the landing page may contain other various links, tabs and information in any variety of multi-media formats in accordance with the scope and intent of aspects of the present invention.

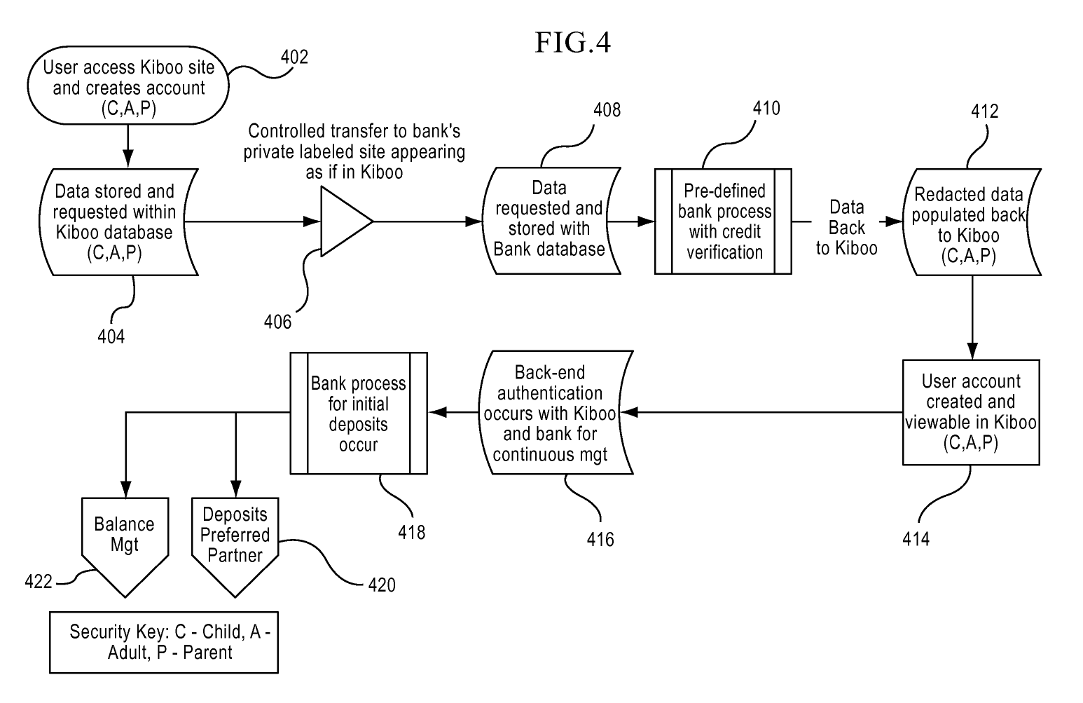

FIG. 4 illustrates an exemplary account creation process and related features, in accordance with aspects of the present invention. The process begins when a teen, adult or parent (e.g., guardian) accesses the web server, which hosts the Web site, for example, for creating an account 402. When a user decides to create an account, the user may be presented with a page with options (e.g., three options), to create an account, such as a Teen, Parent, or an Adult account. An application wizard may be activated to aid the user in filling in a request form that asks for a variety of information, with required information for establishing a bank account highlighted. For example, establishing an account may involve providing name, date of birth, social security number, address, e-mail address, guardian's name (if under 18), parent's date of birth, parent's social security number, parent's e-mail address, and/or a user ID and password combination, in accordance with applicable Security Assertion Markup Language (SAML) standards. If the account applicant is a teen, an e-mail notification may be sent to the teen's parent to complete the correspondent registration process, once the teen information is complete. The teen may not gain access to all features until the parent completes registration.

The registration process may include reading and consenting to an electronic disclosure, and accepting the terms and conditions for creating an account on the FNBS. Account data may be requested and stored in the FNBS data repository 404, such as name, date of birth, address, e-mail address, guardian's name (if under 18), parent's date of birth, and/or parent's e-mail address. The web server may be established to seamlessly communicate and control transfer of information 406 to a bank's private labeled web server so that data may be requested and stored in the bank's data repository 408. In this manner, although it may appear as if the user is on a Web site, the information may be used to simultaneously authorize and, if approved, establish a bank account at an approved partner bank. For the protection of certain confidential and protected information, such as social security number, some user information may only be stored in the bank's data repository.

As shown in FIG. 4, the data transferred into the bank's database may be subjected to a pre-defined bank process, including credit verification 410, for example. A login may be set up within the bank for on-line account balances, and the information/procedure may be transferred back to the FNBS database repository for future bank authorization permissions. The redacted data may be populated back to the database repository 412. The seamless integration of the FNBS web server and the bank's system may enable an approved user to create a user account with a bank, in which bank information is viewable via the FNBS web server 414. With communication thus established between the FNBS and the bank, when a user accesses an account via an FNBS web server, for example, the backend authentication of the bank login and verification may occur automatically 416. The continuous management of the bank account may be handled via an FNBS web server, and address changes, for example, may be requested via the web server and subsequently transferred back to the bank. Initial and future deposits, for example, outside of preferred partner or charter partner deposits and the mobile deposit of checks (discussed subsequently herein), may occur according to established bank rules 418. Aspects of the present invention may thus permit deposits with preferred/charter partners 420, as well as bank balance management 422, respectively, for example, to be effectively tracked and managed by account access via an FNBS web server.

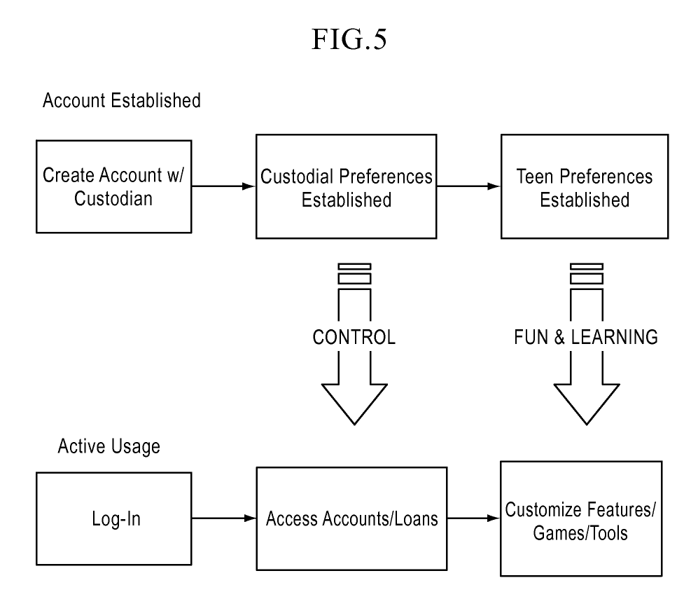

As shown in FIG. 5, in the case of a joint account, once a user account is set up, the custodial preferences may be established, for example. Custodians may have “superuser” status over the account and may establish their own password for separate access to the account. A variety of personal accounts for the teens (or other users) may be established, including, among others, hybrid savings/money market accounts, certificate of deposit accounts, trust accounts and investment accounts. The custodian (or other account authority) may set up direct deposit for a weekly allowance, for example. One aspect of the custodial preferences may include controlling access to the money or how a debit/credit card may be used for purchase. For example, a custodian may decide to retain the ability to control when certain permissions are granted or certain services are allowed to be rendered to a user (e.g., a teen). For instance, a custodian may not feel that a 14 year old teen is mature enough to obtain a debit card. But when that teen turns 16, the custodian can allow this capability by updating the custodial preferences. Or a custodian may place a control on withdrawals or block purchases for alcohol, cigarettes, pornography, or gambling, for example. Custodial preferences may be provided in tandem with custodial waiver forms that the custodian needs to sign to extend certain permissions, such as the ability to sign checks without an adult co-signer or to use a credit or debit card independently.

As shown in FIG. 5, after the custodial preferences are established, the teen may set up their own preferences. Each teen may select a unique password for account access. The custodian may be notified or have access to the teen's password and other appropriate information. This approval allows the custodian to have ultimate control of the custodial account until such teen reaches the age of majority, for example. The Web site may then allow account holders to custom design Web site pages with a variety of options, including, among others, background and layout colors, objects, cartoon characters appropriate to the banking area for that age group, or sports team logos or figures, for example. The cartoons or other friendly mechanisms may be graphically used to display different features of the system, such as a countdown to the next allowance deposit or a bicycle being built one piece (e.g., wheel, frame, handlebar) at a time as the account holder saves enough money toward the purchase of a bicycle.

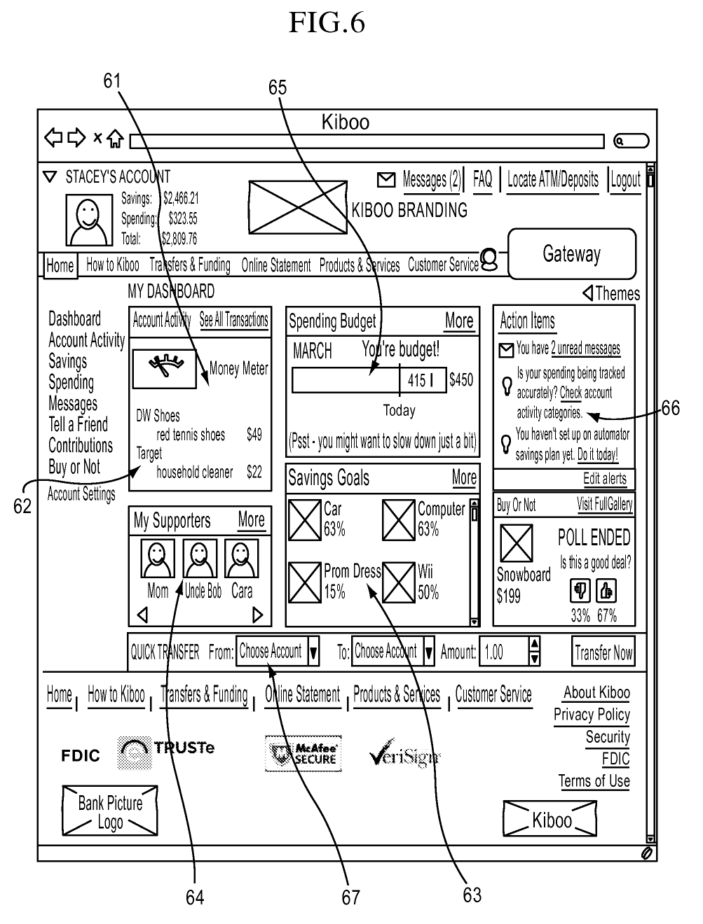

Each user may have a Personal Web page (e.g., dashboard page) on which account status and the different Personal Web Page features are provided. As shown in FIG. 6, a user's Personal Web page may include such information as account balances 61, a list of the recent transactions 62, a scrollable list of savings goals 63, a list of supporters 64, a spending budget 65, where users may access a summary (e.g., a graphical representation) of a current budget status and tips provided from an FNBS database, action items 66 with tips provided from an FNBS database, and a “Buy or Not” section 67 (discussed further herein) with basic information about the latest poll (e.g., name, thumbnail, price, poll question, and result of voting), as well as a link to more details about each Buy or Not poll opened by the user. A quick transfer bar 68 may also be provided that allows users to transfer funds from one account to another while providing as few details as possible. A user may be required first to select from a drop down menu the account to transfer from (e.g., spending or savings) and then the account the money needs to be transferred to, which may not include the “from” account. The user may enter the amount to transfer and select the respective button/link provided to complete the transaction.

Throughout the web site, the user may have the ability to upload photographs or other information to enhance the experience of certain features. Each picture, for example, that is uploaded to the FNBS may be stored in a photo library for future reference with respect to other features as applicable. When a user wants to use a photograph for the different features of the site, for example, the user may select from a photograph already uploaded to the photo library.

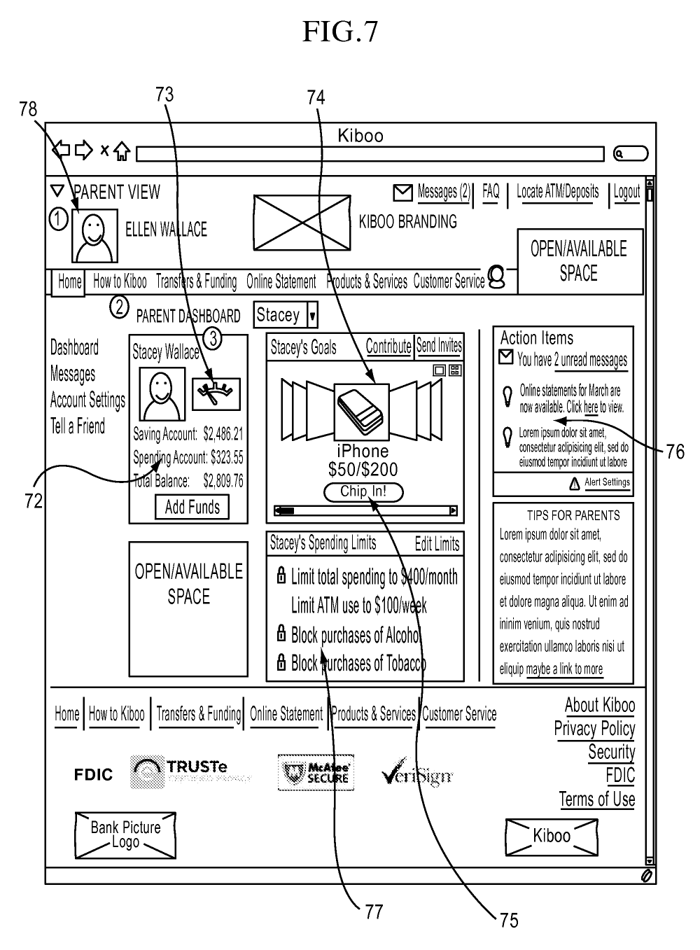

As shown in FIG. 7, parents may have a separate Parents Web page (e.g., parent dashboard). The parent dashboard may contain features that include the teen's account overview, with a quick-look account balance 72, and a money meter section 73, similar to that of the teen. The parent dashboard may also display the teen's goals 74, where a parent may access information on the teen's current goals, each goal containing, for example, name, a thumbnail, progress made toward goal, and a link 75 to contribute to that specific goal. To access the details of any specific goal, a link may be for access to the goal's detail page. Links may also be provided for contributing to the teen's account without specifying a particular goal, and to invite other people to contribute to a teen's goal, for example. A section with information about the teen's limits and restrictions 77, as setup by the parent, and a link to edit the restrictions, may also be provided. A list of action items 76 with tips from the FNBS database and link to the user's messages and alert settings may also be provided. If the parent has several teens, a drop down menu 78 or other selectable feature may be provided, with the names of each teen, for example, so the parent can select which teen's account to access and navigate.

Parents, guardians, or custodians may continuously interact and update preferences as appropriate for a teen. The ability to interact in this manner has enormous potential, including allowing divorced parents to have an integral role in a teen's fiscal development, with minimal interaction between the parents. Also, a parent or guardian that might be away on business, or a military parent or guardian away on assignment, for example, may interact with the teen through the banking system. For instance, a parent can check to see if a teen completed chores and pay or withhold allowance accordingly. A custodian can establish one-time deposits for certain achievements or milestones. The opportunities for a custodian to teach the teen valuable life lessons through aspects of the present invention may thereby only be limited by a custodian's ability to connect to the Internet.

Another exemplary variation of the systems and methods in accordance with aspects of the present invention includes alert functions that may appear on a teen's link page to indicate that the teen has failed to complete chores and/or that allowance is in jeopardy or is being withheld, for example. Additionally, a help function may be provided so that custodians or teens may access multimedia tutorials on certain aspects of money management and banking, or have frequently asked questions answered in an easy and informative format. A live chat function may be made available to users, so that a user may have person to person contact with a knowledgeable individual to answer questions directly, for example. Similarly, users may also be able to e-mail questions to the FNBS, if desired, for example.

Many interactive features on the Web site may be geared toward teaching teens the value of money and fiscal responsibility. These features may include an interactive list of graphical products from which users may select. The users may be prompted to provide the necessary details to establish a saving goal, such as the title of the product and the price. To assist users in this process, the Web site may be linked to multiple vendors, which may also provide an opportunity for advertising products that a user has identified, for example. In this way, a user may learn to shop and compare products, while observing the impact of choices on the ability to accomplish the goal of purchasing a product for which that teen has been saving, for example. These features may be further enhanced by permitting a user to reach out to select friends and/or family to solicit advice and or opinions with respect to financial decisions or goals being contemplated and/or already made.

As FIG. 5 further illustrates, once the custodial account is established, a teen or a parent or custodian can log into the account. Multiple links may be presented to different pages that can be controlled through the custodial preferences or teen preferences. Pages may include an account history page that displays the detailed transaction history and account activity, for example. Links to educational tools may be available through predetermined menus, as well as quick links established at points in the system where access to a tool or feature would be beneficial.

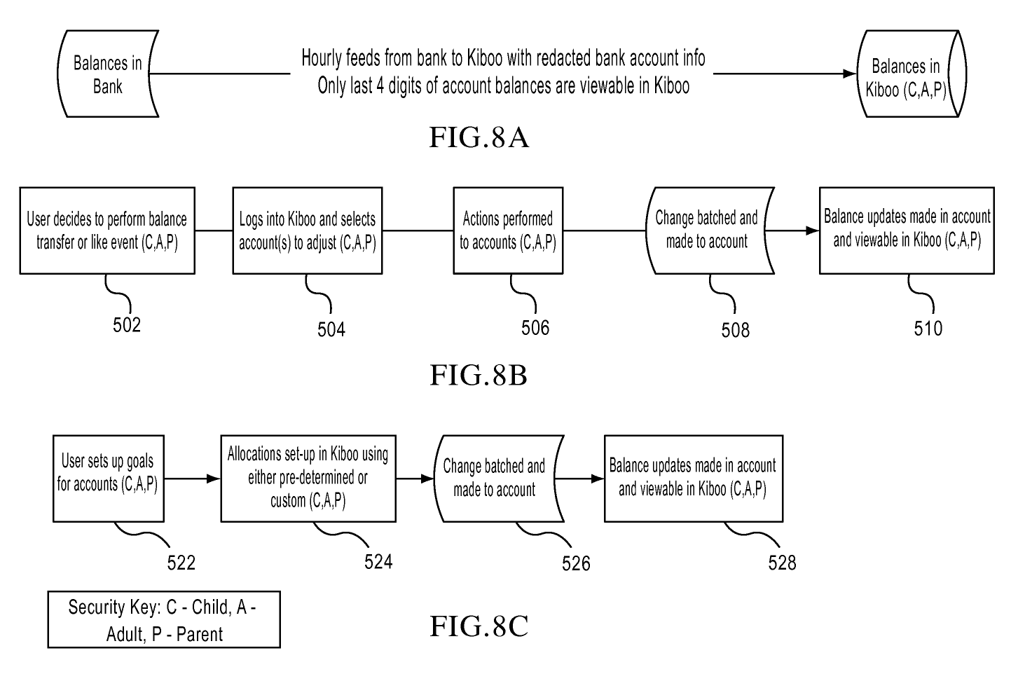

A user may effectively track and manage bank account balances by accessing the Web site directly on-line or through use of a mobile application, as configured for use on a mobile device, for example. FIGS. 8A-8C provide flow charts depicting an exemplary balance management process and associated communication protocol in accordance with aspects of the present invention. As shown in FIG. 8A, the bank may transfer redacted bank account balance information to be stored in an FNBS database repository on an hourly basis. As shown in FIG. 8B, a user may perform a balance management function 502, such as a balance transfer between accounts. The user may access the web server by logging onto their account and selecting which accounts to adjust 504. The actions requested may be performed on the account balances as stored in the database repository 506. The changed account balance information may be accessible to a user using the on-line or mobile applications 508, but the actual bank account changed balance data may not be updated until the batched data is transferred to the bank on, for example, an hourly basis. The balance updates may be indicated as officially made to the bank accounts, once completed 510, and may continue to be accessible via the web server to the account holder.

In FIG. 8C, a user may set up goals for accounts 522, which may determine the allocations of account balance transactions for transfers, deposits and/or withdrawals. The allocations may be set up by a user according to a pre-determined allotment or custom allocations may be selected for any and/or all transfers, deposits and/or withdrawals 524. As discussed above, the account balance information, in accordance with the user's allocation preferences, may occur 526 and be later made accessible 528 via the web server after a transfer, deposit and/or withdrawal transaction. The change data may be batched until the next feed to the bank at which time the official bank balances are changed to be synchronous with the changes made via the web server.

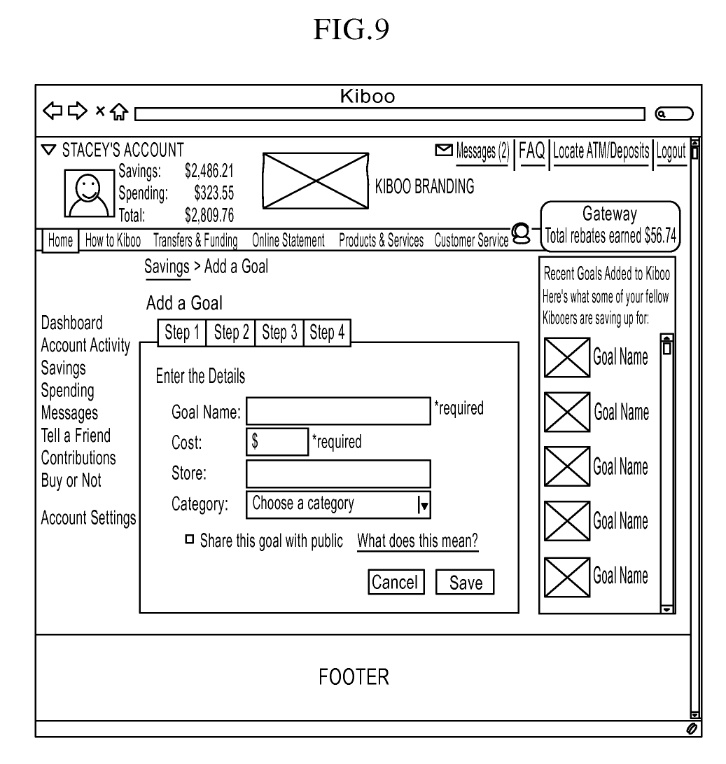

A user may define a set of goals, both short and long term, in order to encourage saving money and learning more about the efficient management of expenses and savings. As shown in the wireframe diagram of FIG. 9, the user may navigate to the “add a new goal” web page, for example. The user may provide information regarding the goal, for example, which may include a name, store, category, amount of money to be saved, period of time between contributions, start date for contributions, day of month/week when contribution will be made, a link to upload a photo for the goal, and an option to make the goal accessible to the user's “public.” A scrollable list, for example, may keep track of recently added goals, and a goal calculator may be provided to assist the user determine how to set savings required in order to accomplish the goal. For example, a calculator may indicate to the user either the expected date to reach the goal (if a contribution amount has been specified) or the contribution amount per month/week needed (if the expected date to finish has been specified). A user may be able to edit a goal from the current list or remove a goal from the current list. If a goal is removed, money from the contributions allocated to that goal may be re-allocated to a general savings category, for example. Alternatively, a user may opt to move the amount saved toward a removed goal to another goal.

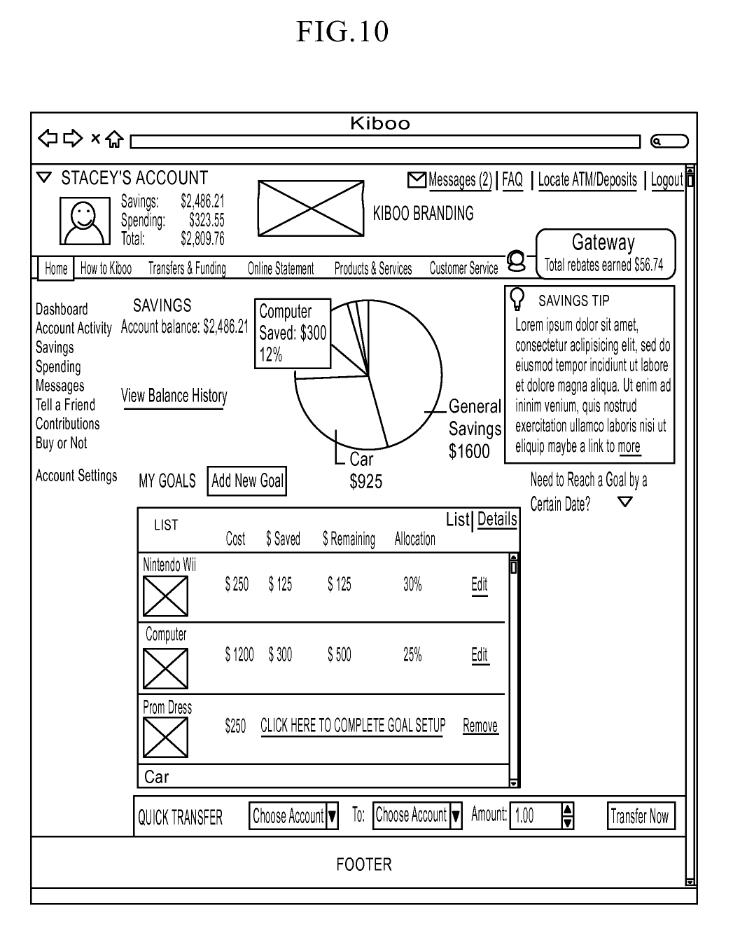

A user may be able to manage current savings in the FNBS. A link will be provided on the user's dashboard page to access a current savings balance, with a pie chart thumbnail and a list of personal goals, for example, as shown in the wireframe diagram of FIG. 10. Thumbnails may indicate the progress toward reaching each established goal. Links may be provided to a savings analysis, which may indicate a breakdown of goals allocation and general savings, with visual elements, such as pie charts, to help the user better understand the information and to access the savings transaction history.

In another variation of the present invention, the FNBS may provide automatic alerts or other selected or automated prompts to keep users informed about important banking activity as appropriate for when it happens. Information alerts may include an overdraft alert if a transaction exceeds available balance, a current balance alert sent after a transaction/deposit, a low balance alert if an account falls below a user-defined minimum balance, and/or personalized tip alerts, for example. Security alerts may include a login ID and/or password change alert, a mailing address change alert, and/or an excessive spending alert if, for example, a transaction or ATM withdrawal exceeds a user-specified amount. The user may be able to select which information alerts the user would like to receive, as well as the delivery method. Parents and teens may be able to individually set up and receive alerts on a joint account. They may also be able to update/edit alert preferences through the Web site and, in particular, personal pages. To update alert preferences, a user may navigate to the appropriate web page and select from a list of check boxes the alerts to enable or disable. Also, for each alert selected, another list containing the alert delivery methods available may allow the user to customize how the alerts are delivered. Available delivery methods may include, for example, a text message to the user's mobile device, an e-mail, or a web application alert within the user's profile that appears or may be selected for viewing when a user logs in to the account.

A user may also send text message requests using the FNBS to, for example, receive account balance information, view transaction history (e.g., recent transactions, ATM withdrawals, deposits, debit card purchases, checks, interest posting, bank fees), or locate nearby ATMs or cash deposit locations. Each one of the text message requests may have a code assigned so a user may send the text message with that code as content (e.g., to receive account balance information a user may text “BALANCE” to a specific number). The web server may receive the messages through a third party system and may parse the input messages to prepare an automated response, for example, or send the message along to an assistance center for further action.

Additionally, the network site or other access system can provide the ability to create e-mail distribution lists, by either the custodian or teen, or both, for example. Graphical figures may be used to present links to the lists on the account holder's page. For example, upon the occasion of a teen's birthday, selecting a birthday cake icon could send an e-mail to a particular distribution list, notifying those on the list that they can make a deposit or transfer using a credit card or Automated Clearing House (ACH) transfer. Such contributions could then be tracked and displayed on the teen's statement, so the teen, as well as the custodian, can further observe, and control if need be, the transactions.

As discussed above, the transactional controls may be maintained in the custodial preference side of the system. For instance, a custodian might want to control how much money can be provided to the teen for a certain occasion. To illustrate, a grandparent goes to the Web site to make a deposit to a grandchild's account for a birthday gift. The custodian might have set a limit of $25 for any birthday gifts. The teen and custodian would then log-in or receive and notification in some manner to check the account. The statement or transaction history can be viewed to see that the grandparent made a deposit of $25 on a certain date.

Account holders may be able to make contributions to other user accounts on the system. Contributors, for example, may include user account holders who want to transfer money from their account to a friend's account on the system or purchase a gift card, as well as third party visitors without an account, such as relatives and friends. Funding options for those wishing to make a contribution may include an internal transfer for FNBS account holders only, credit/debit card transactions, and/or wire transfers or ACH transfers. Contributors may have an opportunity to write a message to the recipient that will be included in a notification e-mail to the user. The contributor may also choose to upload a thumbnail image to the Web site that may appear on the user's personal pages in a “My Supporters” section, for example. Contributors may also have an opportunity to set up regularly scheduled contributions, which may be deposited (e.g., automatically) into the user's account on a specified date.

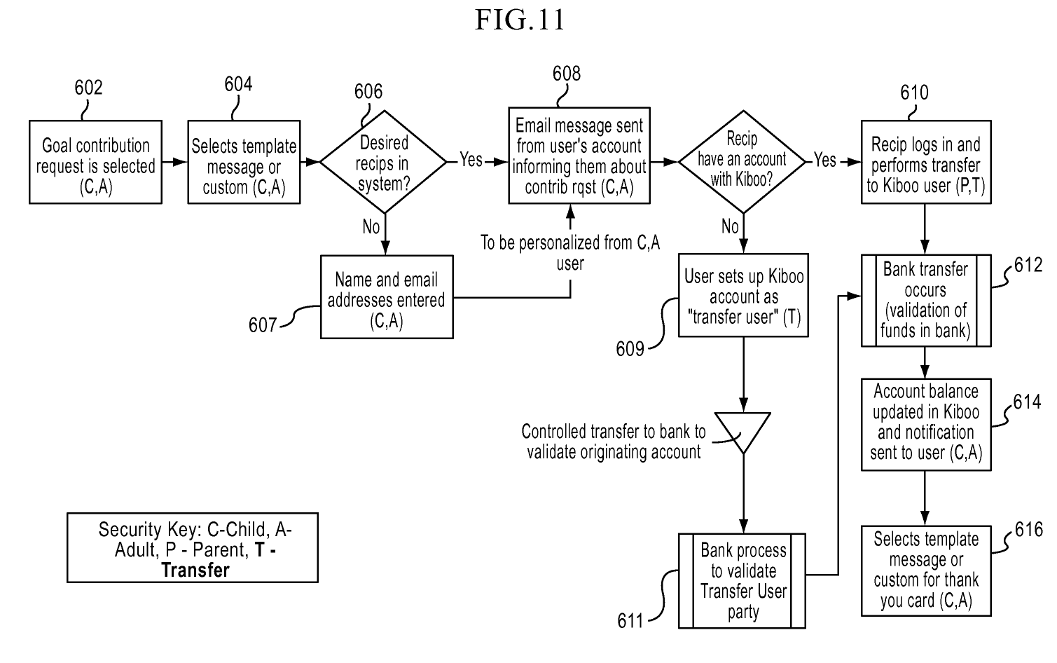

FIG. 11 illustrates an exemplary process flow for a third party transfer of funds to a teen in which the third party is also an existing account holder (e.g., a parent or guardian or established “transfer user”) or wishes to create a “transfer user” account. As depicted in FIG. 11, the teen may make a goal contribution request to one or more recipients through the teen's personalized account 602. A teen may select from various template messages or may create a customized goal contribution message 604. A determination may be made as to whether the desired third party recipient(s) have already created accounts 606 and, if no account exists, indicate that a request is made for the teen to enter the name and e-mail addresses of the third party recipient(s) 607. An e-mail message may be sent from the teen's account informing the recipient(s) of a contribution request 608.

As also shown in FIG. 11, if a recipient of a contribution request has an account, the recipient may log in and perform a transfer to the teen's account 610. A bank transfer may be made according to bank procedures after validation of covering funds, and the bank account balance of the user may be updated 612. The account balance of the teen may then be updated on the database repository, and notification may be sent to the user of the successful contribution 614. The teen may select from a template message or create a custom thank you message in response to the third-party contribution 616.

If a recipient of a contribution request does not have an account, the recipient may set up an account as a “transfer user” 609. A controlled transfer may be made to the bank of the information necessary to validate the transfer user's originating account. The bank processes the transfer user's request in a bank process to validate the transfer user 611. Once validated, the transfer may be made according to bank procedures and the validation of funds and the bank account balance of the user updated 612. Once again, the account balance of the teen is then updated on the database repository and notification is sent to the transfer user of the successful contribution 614. The teen may then select from a template message or create a custom thank you message in response to the third-party contribution 616.

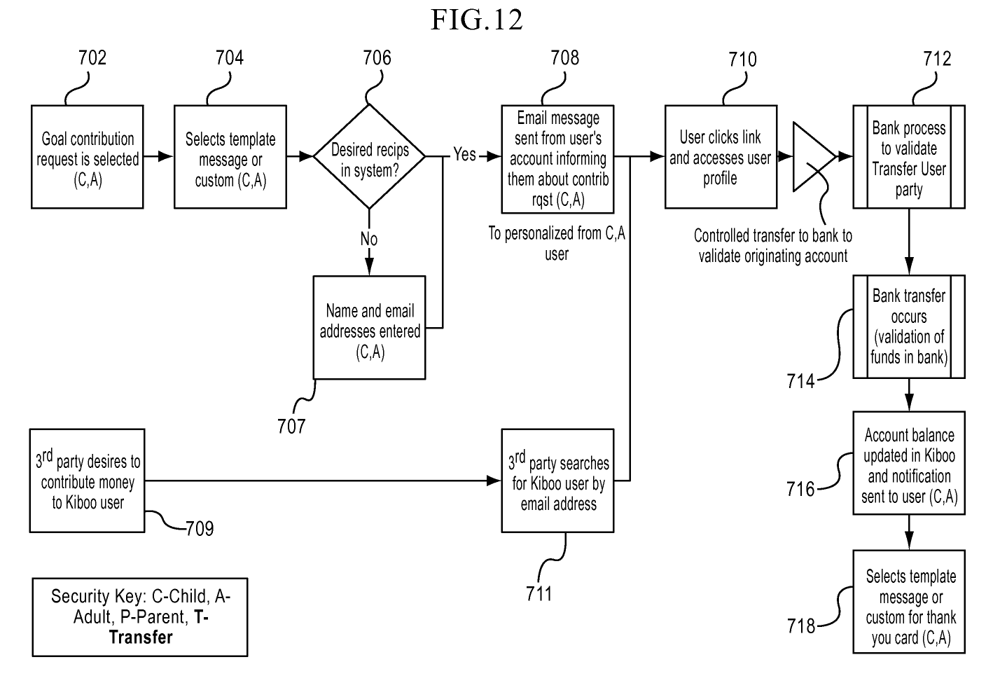

FIG. 12 illustrates an exemplary process flow for a third party transfer of funds to a teen, in which the third party does not wish to create an account or independently seeks to contribute money to a teen using the FNBS. As depicted in FIG. 12, the teen may make a goal contribution request to one or more recipients through the teen's personalized Web site account 702. The teen may select from various template messages or may create a customized goal contribution message 704. A determination may be made as to whether the desired third party recipient(s) name and e-mail information already exists in the FNBS 706 and, if not, indication may be provided for the teen to enter the name and e-mail addresses of the third party recipient(s) 707. An e-mail message may be sent from the teen's account informing the recipient(s) of a contribution request 708.

A third party user may also independently seek out a user to make a contribution to a user's account. The third party user may desire to contribute 709, and they would navigate to the Web site and search for the teen 711, such as by inputting a known e-mail address. A captcha field may be provided to prevent automated processes from intentionally damaging the FNBS Web application.

Once the third party user accesses the system, the third party user may access a valid user profile for making a contribution 710. The searcher may see a list of goals for the user (if permitted by the user), in order to provide the ability for the searcher to view a specific goal and contribute directly to that goal. If the user being sought by the searcher does not have an account on the FNBS, the third party searcher may be provided with the option to send a promotional code to the user to open up an account, at no cost to the sender. A controlled transfer may be made to the bank of the information necessary to validate the transfer user's originating account, and the bank may process the third party user's request 712. Once validated, the transfer may be made according to bank procedures and the validation of funds and the bank account balance of the teen may be updated 714. The account balance of the teen may then be updated on the database repository and notification may be sent to the teen of the successful contribution 716. The teen may select from a template message or create a custom thank you message in response to the third-party contribution 718.

Another feature of systems and methods in accordance with aspects of the present invention may include providing account holders the opportunity to earn points or promotional “dollars,” for example, by using the many features on the Web site. Points can be earned by playing the game of the week, for instance, or entering the contest of the week. These points may later be exchanged for products or services, per a catalogue or promotional offers on the Web site, for example.

Another variation allows the bank to issue a special credit card-like card for use at participating vendors. A teen could use points accrued by presenting such a card for payment at a participating store, for example. Depending on the type of agreement, the points could be exchanged for a discount on select products at participating or preferred vendors.

Vendors may have the opportunity to advertise on the Web site, for example. This advertising can take many forms, such as banner advertisements from vendors that are directed toward teens or adults. For example, when a teen's bank account balance reaches a certain figure, display of a particular advertisement or range of advertisements could be triggered, as appropriate or as established by a user-defined profile. This advertising could be further delineated by banking area, so advertisers will know that advertisements can be directed to a specific and appropriate audience. Disclaimers and features may be used to ensure that the advertisements are not associated with or sponsored by the bank itself.

Preferred vendors may also be selected by navigating to a vendor mail, e.g., a gateway, for example, on the system's Web site. The vendor mall may serve as an on-line shopping center that is a part of the FNBS, and may be restricted to, users of the FNBS. The vendor mall may indicate storefronts or “doors” that serve as portals to actual online stores. A user may decide whether to access only those retailers or vendors of interest or access a complete listing of all participating retailers or vendors. When a user selects a specific store from the mall, a shopping frame may be accessed from which the user may access the store details and purchase products. A user may add or remove stores on the featured list according to personal preference.

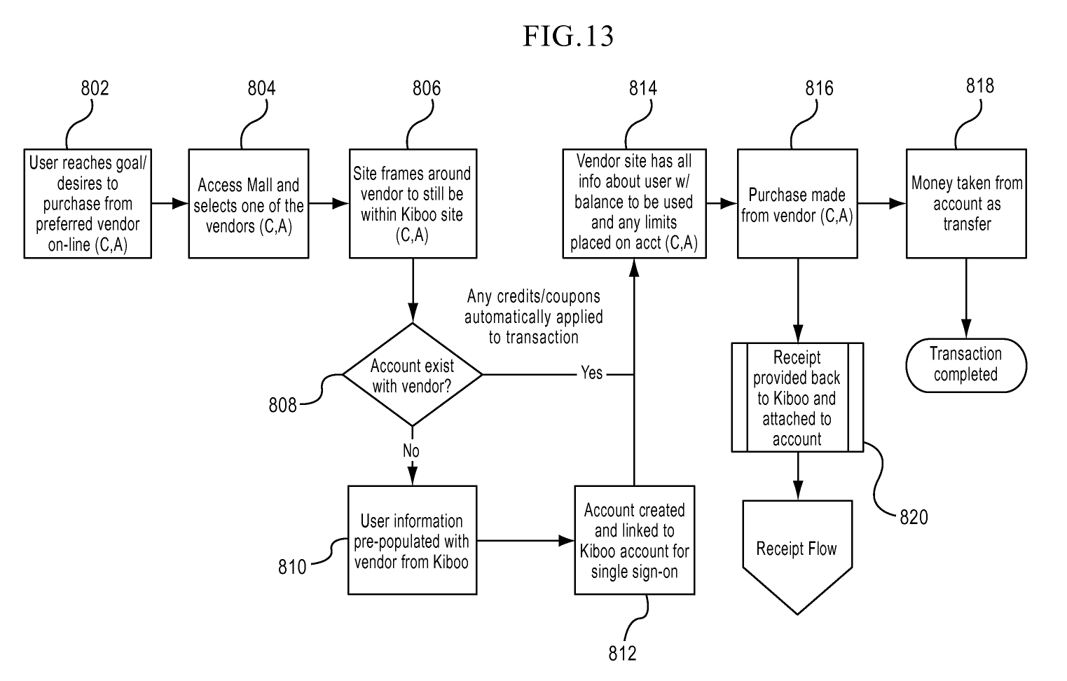

As shown in the process flow of FIG. 13, the on-line shopping experience may be tied directly into the goals of a user 802. A user may reach a savings goal, for example, and desire to purchase a product or service from a preferred vendor. A user may access vendor information and offerings by visiting the vendor mall (e.g., Access Mall), for example, through a link on the Web site 804. Although a user may be viewing vendor information, the site frames around each vendor site in the vendor mall may still be within the Web site of the FNBS 806. A determination may be made as to whether the user has an account with a selected vendor 808. If not, user information may be pre-populated from the database repository into the vendor request form 810 and any additional information requested by the vendor (e.g., ship to addresses) may be entered by the user. A vendor account may be created and linked to the user's account on the FNBS so the user may have a single sign-on and login 812. Once the user has a linked vendor account, the vendor site may have access to balance information and any limits or restrictions placed on the account by the user and/or a parent, for example 814. Any credits/coupons may be automatically applied to the transaction if necessary. Once a user makes a purchase from the vendor 816, money may be withdrawn from the user's account 818 as a transfer and the transaction completed. A vendor receipt of the purchase may be provided back to the FNBS and attached to the user's account 820.

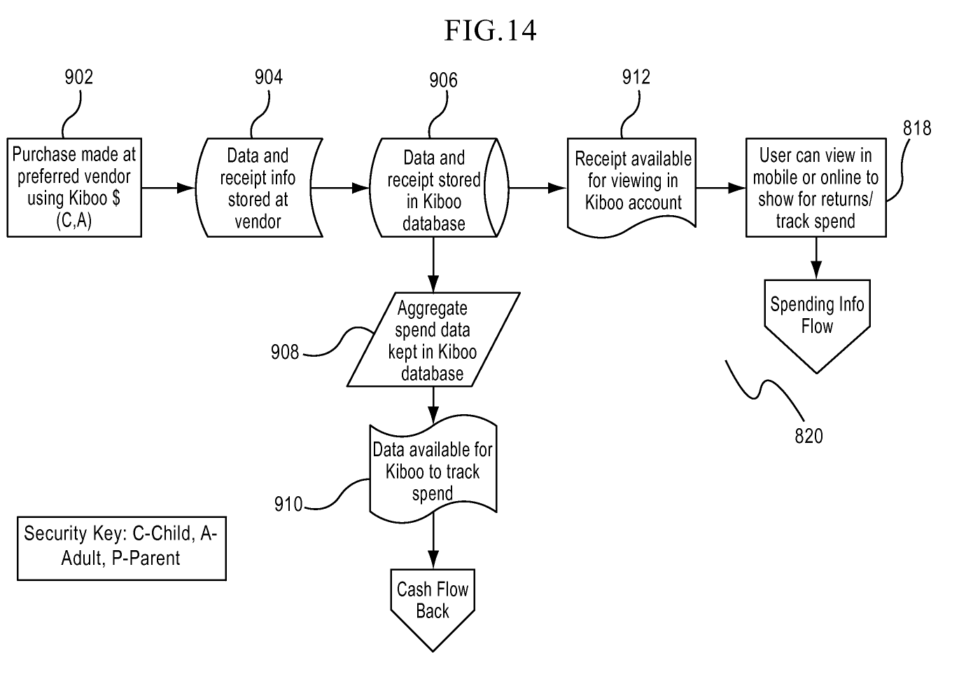

FIG. 14 provides an exemplary flow chart for the receipt delivery process when making a purchase from a preferred vendor. The receipt tracking allows users to maintain electronic records of purchases, including those made at participating vendors, for example. The purchase history, including receipt records of a user, may be viewed by the user on-line or from a mobile device, eliminating the need to constantly keep and store paper receipts. The purchase may be either a direct purchase or a purchase using a rewards card, for example, depending on the account profile and status of the individual user. As shown in FIG. 14, a user may make a purchase at a preferred vendor using money or credit from one of the user's accounts 902. The data and receipt information from the purchase may be stored at both the vendor 904 and in the data repository of the FNBS 906. The FNBS may aggregate the user's spending data 908 so the data is available 910 for tracking spending within the system. The receipts of vendor transactions may be made available to users for viewing and/or reproduction, for example, by providing a link on the user's personal and individualized account Web site on the FNBS 912. As such, a user may be able to view on-line or on a mobile device the vendor receipts which may be used for returns, for example, or to track spending 914.

In this manner, a user may be able to exchange or refund purchases directly through the use of a mobile device, for example, by calling up an electronic receipt for presentation or submission to the vendor. For example, the vendor may directly scan the bar code on the receipt that is called up and displayed on the mobile device while a user is at the vendor's location. The banking system may include a real-time updating capability to receive receipt data from participating vendors, for example, or the system may receive/transmit a daily or timed exchange of user records with a vendor for electronic receipt tracking and storage. The receipts may be stored and organized according to a user's preference, for example, including by date, location, vendor, product category, or stored according to preset allocations. As such, the mobile device may also receive and display bar codes corresponding to a particular vendor's electronic coupons or gift certificates, for example. The user may open a link from the mobile device, for example, and the bar code on the coupon can be scanned by the retailer and applied on the spot to a purchase.

In operation, the FNBS may provide specialized access and marketing opportunities to preferred partners or charter partners. In return, the preferred partners and/or charter partners may offer users incentives or specialized services, for example. The FNBS may provide a seamless integration with the vendors designated as Charter Partners. When accessing a Charter Partner from within the FNBS's Web site, the Charter Partner's Web site may be framed so that the user never leaves the FNBS's Web site. A user may link a Charter Partner account to the user's account on the FNBS so the user does not have to log-in again each time the user visits a Charter Partner Web site. If the user does not have an account with the Charter Partner, one may have to be created with the vendor. The FNBS can pre-populate certain information about the user (e.g., name, address, email) during the process of setting up an account with the Charter Partner. Upon accessing a Charter Partner site from within the FNBS, any applicable coupons or discounts may be applied to the user's cart (e.g., automatically). At the time of purchase, a user may be defaulted to utilize a form of payment tied to a user's account on the FNBS, such as a debit or credit card. Additional methods of payment may be selected, but a cash back premium reward incentive may only be obtained by utilizing the user's account on the FNBS.

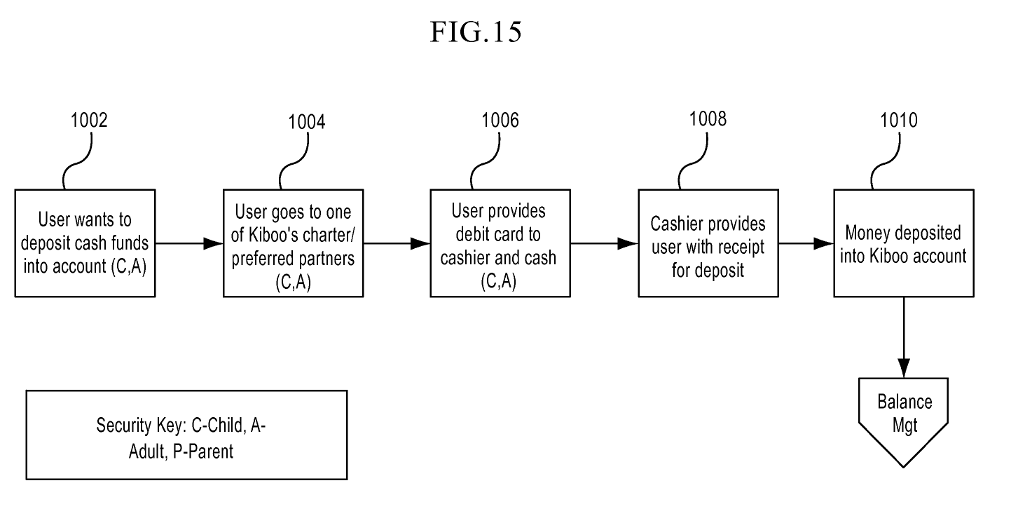

With respect to incentives by way of coupons or discounts on items identified as goals, for example, FIG. 15 shows a process flow for a specialized service in which a user may deposit cash funds. As depicted in FIG. 15, a user may decide to deposit cash funds into an account on the FNBS 1002. The user may go to a preferred partner/Charter Partner's brick and mortar store location to make the deposit, or the user may be able to make deposits on-line or by telephone, for example 1004. The mobile application of the FNBS on a user's mobile electronic device may include a search capability, for example, to find a location of a preferred partner/Charter Partner using Global Positioning Satellite (GPS) technology. The on-line application of the FNBS may include a search capability based on the address of the Charter Partner for making a deposit. The user may provide an account debit card to the cashier along with the cash for deposit 1006. The cashier may apply the deposit using the debit card to access the user's account and provides the user with a receipt of the deposit transaction 1008. The money is deposited into the user's account on the FNBS in accordance with the balance management flow process 1010, further illustrated in FIG. 5C.

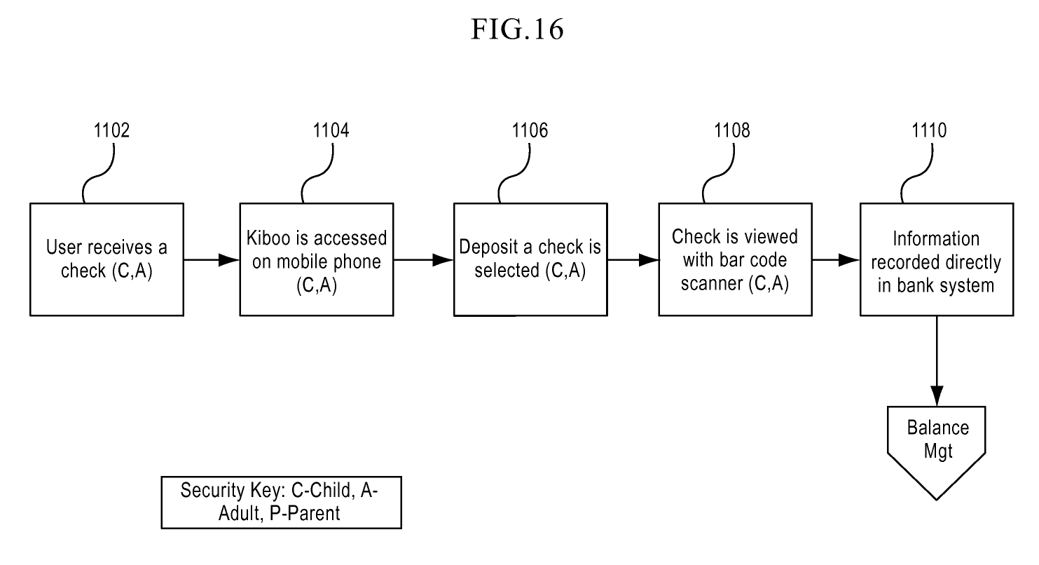

As shown in FIG. 16, a process for depositing checks may be used with the mobile application of the FNBS to allow a user to deposit checks via a mobile electronic device, such as a cellular telephone. As depicted in FIG. 16, a user may receive a check for deposit 1102. The user may access the FNBS from the mobile electronic device 1104. The user may select an option for depositing a check 1106. A picture of the check may be taken using the mobile electronic device's built-in camera, or a bar code scanner at a preferred partner/Charter Partner may be used to scan the check. A verification application may be used in order to verify the accuracy of the picture and/or scan for sending the information directly to the bank in a manner that is acceptable for processing.

Another variation of the present invention may include an option for a user to have paper checks created and mailed to another party. In order to do this, a user may have to provide certain required information regarding the person who will receive the check. An e-mail may be generated and sent to the user confirming the action performed. Alternatively, if the user doesn't know the exact information of the recipient, the user may provide the phone number, for example, and the FNBS may search for that person and obtain the required information. Users may have the option to save the recipient's information in order to send future checks without having to enter the information again. In this regard, users may be enabled to set up selectable or automated transactions that the FNBS will make to a third party on a regular basis, based on the frequency and amount provided by the user.

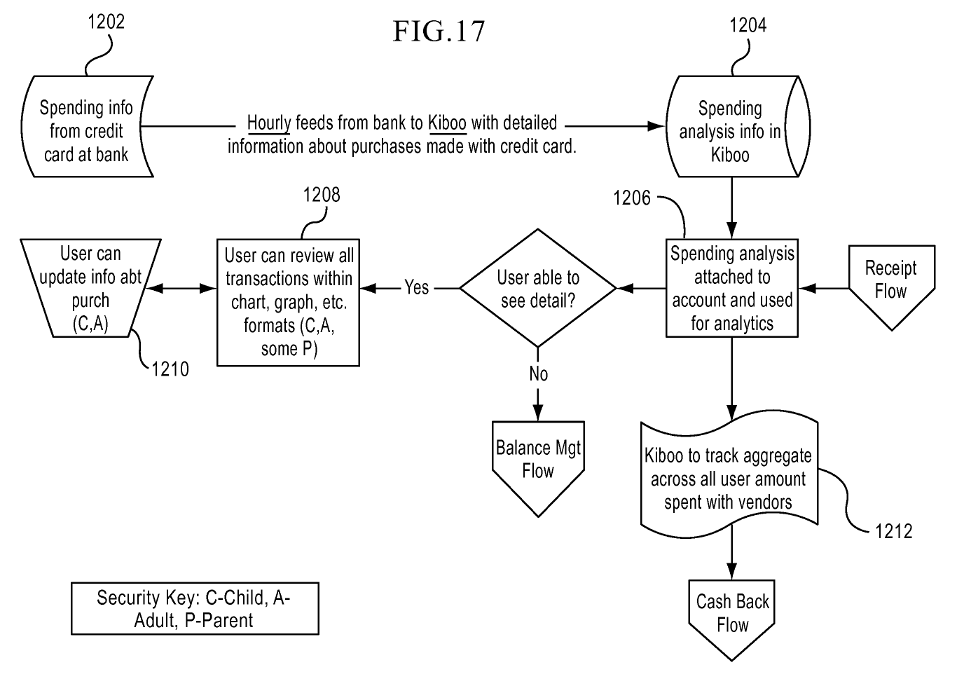

FIG. 17 illustrates the process flow of spending information on purchases and withdrawals using the bank issued credit card for use with the FNBS. As shown in FIG. 17, detailed information from a user's transactional spending through use of the credit card 1202 is fed from the bank in hourly feeds to the data repository of the FNBS 1204. As depicted, the FNBS compiles spending analysis data, including a feed from the receipt delivery process (see FIG. 10), for use in individual and system-wide data compilation and analysis 1206. In comparing the data received from the receipt delivery process, duplicate transactions, e.g., those transactions that match a credit card purchase, are notated based on vendor identification and the amount of the transaction. The data incoming from the receipt delivery process will override data received from the bank regarding credit card transactions.

If a user is able to access detailed transactional information, based on preferences and parental controls, for example, a user may review the transactional data 1208 in various formats, such as lists, charts, and graphs. A user may manually enter additional transactional spending data that falls outside of the automated tracking of credit card and receipt transactions 1210. For example, a user may be able to enter detailed information about cash expenditures using money withdrawn from an ATM.

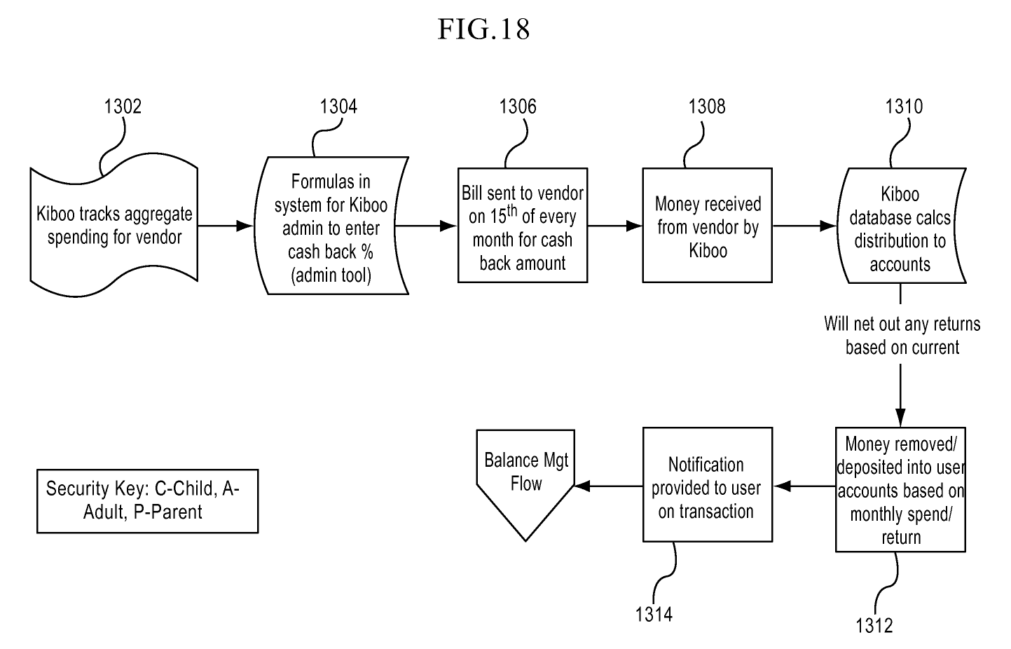

The FNBS may additionally track aggregate system data, including, for example, the aggregate spending of account holders at preferred vendors or Charter Partners 1212. This aggregate system data may be used to provide a cash back incentive based on the process illustrated in FIG. 18.

As depicted in FIG. 18, the FNBS may track the aggregate spending of all users at each vendor 1302. Based on individual agreements with each vendor, for example, the FNBS may determine a cash back percentage of the aggregate total spent at a particular vendor, netting out any credits and debits due to returns of merchandise, etc. 1304. The system may then generate a bill that is sent to each vendor on a predetermined basis, e.g., monthly. When the money is received from a vendor 1308 the FNBS distributes any net returns based on database calculations of an individual's share of the cash back amount from that particular vendor 1310. The vendor money may be deposited into individual user bank accounts based on the individual's monthly spending share/return total 1312, and notification provided to the user on the transaction 1314. The transaction may then be processed according to the balance management flow of FIG. 6A, and the new balance is updated and viewable via the web server, for example.

Mobile applications may be separately developed and integrated into the FNBS to enhance the experience of users accessing the FNBS from a mobile device, such as a mobile telephone. For example, a “Buy or Not” application may allow a user to reach out to a network of friends and family for advice before spending for a purchase by providing the user with the ability to create a poll. The user may create a poll for a specific item being considered for purchase, by providing the following information, for example, name/label, brand, price, retailer, description, a question, a time limit, and/or a picture of the item. Once a poll is created and saved by the user, the information may be sent to the web server, for example, and a dedicated FNBS web page generated that displays the user's entry and includes an interface for voting and leaving comments. The user may be able to delete polls previously created, and the user may be able to cancel a poll that is currently open. Canceling a poll may mean, for example, placing a stop on all attempts by other users to vote on the poll, and enabling the user to inform recipients by sending an e-mail, text message and/or adding a notification to the user's newsfeed on Facebook® and/or Twitter®.

Users may be able to view their Buy or Not polls (both past and current) and perform different operations on each one. A web page may be provided that contains the entire list of polls that a specific user has created and some details about each one of them, including, for example, a thumbnail of the product, name, result of the voting, including number of positive and negative votes and the total percentage for each, time remaining, total number of votes, and whether the poll is open or closed.

Users may be able to add a product from a Buy or Not poll to their personal goals. A button/link or other selection feature may be provided that users may use to add a new goal. Selection of the button/link may result in the FNBS recording the basic information from the Buy or Not product and storing it as a new goal. After a Buy or Not poll may be closed, users may be able to share the result and final decision made with the people that participated in the poll.

Users may also be able to vote on a Buy or Not poll created by another user, once an invitation is received. A user may select the link in the invitation, for example, and complete the information on the page presented. A poll page may include details about the poll and several fields for users to provide feedback. Users accessing the FNBS on a mobile device may be directed to a separate mobile web page for responding to the poll. The mobile web page may also be optimized for viewing on a mobile device.

Users of the FNBS will have the ability to post messages from different features of the Web application to various social networking tools such as Facebook® and/or Twitter®. In order to enable this feature, Facebook® and/or Twitter® may require the user to first authenticate, using the user's Facebook® and/or Twitter® credentials. Once authenticated to Facebook® and/or Twitter®, the FNBS may enable posting of messages to the user's profile on Facebook® and/or Twitter®.

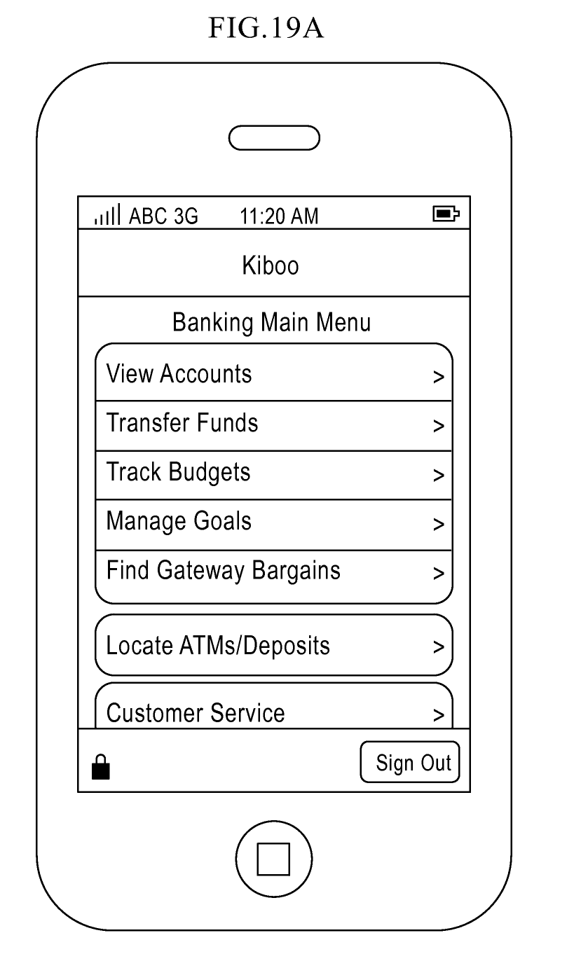

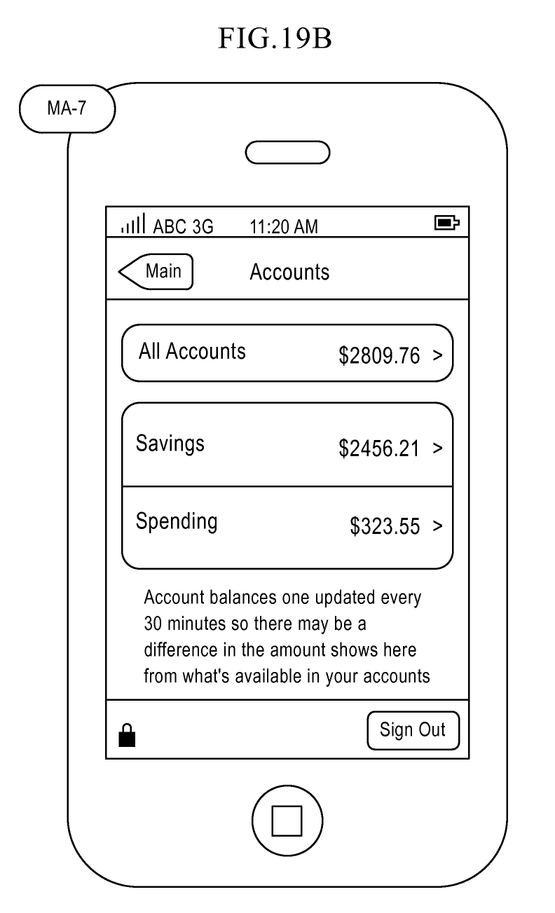

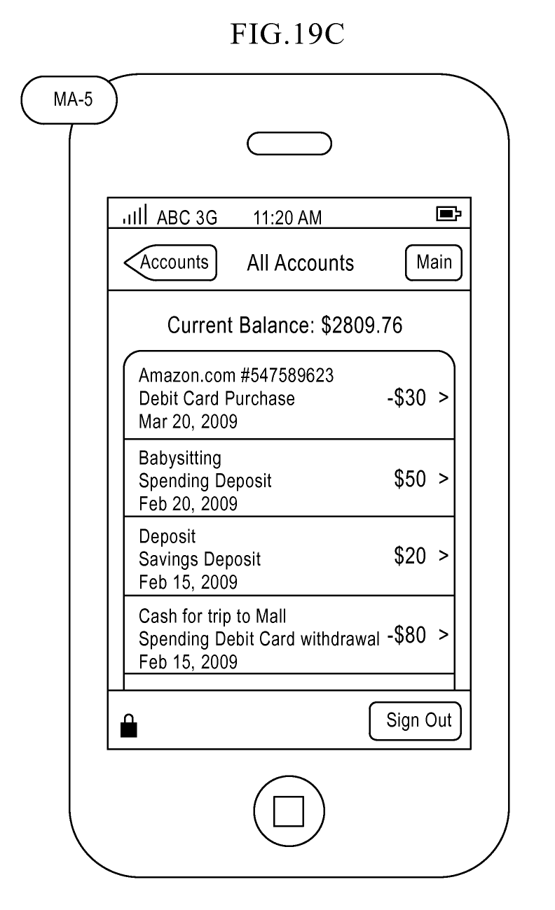

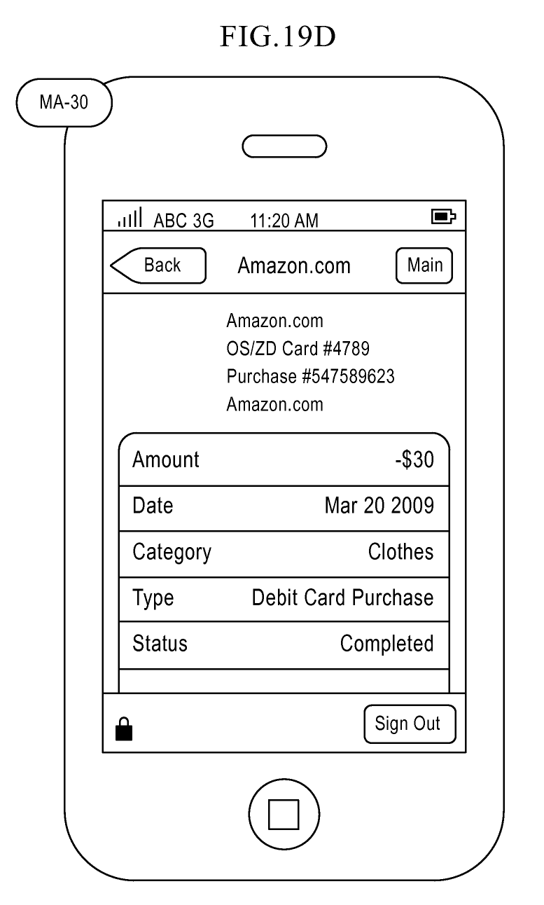

Another variation of the present invention, as discussed herein, provides a mobile banking application that allows a user to access the FNBS and manage finances on the go. The mobile application may not have all of the functionality of the online application. The mobile application, for example, may be able to perform a set of actions from a mobile device that includes viewing account information, transferring funds between accounts, tracking budgets, managing goals, locating ATM and cash deposit locations, and accessing the vendor mall, customer service, and a link to the FNBS Web site landing page. A link/button may also be provided for the user to log into the application. If the user is already logged in, then the link may enable logout of the application. A user may use the same login information on the mobile application as the user would use to access the system from a computer, for example. The session may be set to expire when a user has been inactive for ten (10) minutes, for example. FIGS. 19A-19D illustrate representative user views of the mobile application aspect of the FNBS, as used on a mobile device.

Another variation of the present invention may include a process for manually entering contacts and/or importing contacts to a personal contacts page. The contacts may be imported using an import wizard to guide the user through the import process. Once a user has a populated contact list on the Web site, a page may be created to display the contacts and associated information for use with several functions of the FNBS.

Another variation of the present invention may include a family loan agreement function, taking the form of a promissory note, for example, that earns interest. The family loan agreement function may allow custodians or family members, for instance, to set up, document, and track interfamily/interpersonal loans linked to applicable interest rates. These “loans” typically may not be bank loans, but may serve as another educational tool to promote financial literacy, for example. The family loan agreement can be used as a tool for custodians, parents or guardians, for example, to teach teens the value of money, such as the price to be paid if something is wanted immediately, but the funds to pay for it are not available. This feature could also be linked with other tools for fiscal management and planning.

Other tools provided on the FNBS Web site may include, for example, a budget navigator, such as a spreadsheet tool that allows a user to set up and track a budget. For example, a teen could track revenues against a list of different items that the teen could spend money on, such as gas, mobile telephone expenses, food, or gifts. The teen's goals can integrate with a graphical product builder function, for example, so that items will integrally appear as the budget meets goals. A global awareness function may be provided in the budget navigator tool, for example, to allow the user to easily compare the native price of an item of interest against any foreign currency. A teen that identifies a bicycle in the budget navigator as a goal will thus be able to compare the U.S. dollar price to see how much it would cost in Iraqi dinars, or vice versa, for example. A budget monitor tool may also be provided to permit a user to track how money is actually being spent. Interest calculators and future value of money tools may also be provided to enhance the suite of tools available to teens and custodians. The suite of tools may create an interactive area for custodians and teens to teach and learn the value of money, for example, and the lessons of fiscal management and planning.

An example variation also includes a cartoon character or other friendly mechanism to playfully convey instructional information using intuitive images and minimal wording, helping to minimize frustration and maximize success. Such a cartoon character or other mechanism also may be extendable throughout other product applications, such as for use in marketing and advertising. Games and contests may be provided or devised to further extend the recognizable nature of these characters or cartoons and to generate traffic on the Web site that may or may not be directly attributable to direct banking, for example. The games can be tied to earning points and can also be designed to be interactive, so that multiple teens can join in playing against or with one another.

Another variation provides integrated social networking capabilities, so that users may communicate with each other by sending e-mail or instant messages. Alerts may be posted indicating when a favorite user is logged onto the system, for example. Each user may be able to control visibility to others on the network through customizable settings in the user's preferences profile. Another variation may provide users with the ability to generate or receive e-mail messages while using the system. Along with the interactive nature of games, for example, these features and others may work together to create a fun, educational, and desirable virtual location for users to spend time.

A variation of the present invention may include incorporating coin kiosks into the banking network to allow users to make coin deposits at select vendor or banking locations, for example. In this manner, a user may take a collection of coins to a kiosk location, load the coins into the coin kiosk for counting, and select whether to have a sum of money returned in cash or direct deposited into an account maintained at a bank. An exemplary variation of this aspect of the current invention may include incorporating Coinstar® kiosks and associated features, as described at http://www.coinstar.com/us/html/A1 (last visited on Apr. 13, 2008, and incorporated herein by reference).

Although exemplary variations of the present invention may relate to banking for teens, it can be appreciated that the systems and methods provided herein can be provided for use by those of any age. As such, example variations of the present invention have now been described in accordance with the above advantages. While the foregoing disclosure discusses illustrative aspects and/or variations, it should be noted that various changes and modifications could be made herein without departing from the scope of the described aspects and/or features as defined by the appended claims. Furthermore, although elements of the described aspects and/or variations may be described or claimed in the singular, the plural is contemplated, unless limitation to the singular is explicitly stated. Additionally, all or a portion of any aspect and/or variation may be utilized with all or a portion of any other aspect and/or variation, unless otherwise stated.

1. An electronic financial management and banking system, comprising:
an account creation module for creating a secure user account on the system;
an account balance module for tracking monetary transactions and maintaining an account balance for the user account; and
a goal module, wherein a user establishes a financial goal that is tracked in association to the account balance.

2. The system of claim 1, wherein an electronic request is generated requesting a monetary contribution toward the financial goal of the user.

3. The system of claim 2, wherein a transfer user account is created using the account creation module to enable contribution of funds to the user account.

4. The system of claim 1, further comprising:
a preferred vendor module, wherein a predetermined portion of the account balance is applied to a purchase of a product associated with the financial goal from a preferred vendor.

5. The system of claim 4, wherein an aggregate user spending total for the preferred vendor is determined and electronically submitted to the preferred vendor.

6. The system of claim 1, wherein the user account is configured to provide notice to a user defined contact of a pending purchase by the user.

7. The system of claim 6, wherein the user account is configured to receive feedback from the user defined contact regarding the pending purchase.

8. The system of claim 1, further comprising:
an electronic receipt depository module, wherein an electronic receipt depository maintains electronic receipt data of monetary transactions between the user and a preferred vendor.

9. The system of claim 1, further comprising:
an electronic transaction history module for electronic review of past monetary transactions by the user.

10. The system of claim 1, further comprising:
a custodial control module, wherein a custodian of the user controls aspects of the user account through custodial controls.

11. A method for financial management via a processor, the method comprising:
receiving a request for establishing a user account;
transmitting transactional data to and receiving transactional data from a bank for maintaining an account balance for the user account;
receiving one or more spending goals for the user account;
allocating a portion of the account balance to the one or more spending goals; and
providing feedback of the spending goals and account balance to the user.

12. The method for financial management of claim 11, further comprising:
providing a user interface functioning via the processor, wherein the user account is established via the user interface.

13. The method for financial management of claim 11, further comprising:
storing the spending goals in a repository accessible by the processor for retrieving and comparing the spending goals to the account balance.

14. The method for financial management of claim 11, further comprising:
providing access to vendor product data via the user interface.

15. The method for financial management of claim 11, further comprising:
transmitting transactional data to and receiving transactional data from a vendor for maintaining an account balance for the user account.

16. The method for financial management of claim 15, further comprising:
maintaining the transactional data from a vendor in an electronic receipt depository.

17. The method for financial management of claim 11, wherein the processor is housed on a terminal.

18. The method of financial management of claim 17, wherein the terminal is selected from a group consisting of a personal computer, a minicomputer, a main frame computer, a microcomputer, a hand held device, and a telephonic device.

19. The method of financial management of claim 11, further comprising:
generating an electronic request requesting a monetary contribution toward the one or more spending goals of the user.

20. The method of financial management of claim 19, further comprising:
creating a transfer user account to enable the monetary contribution.

21. A computer-implemented method of financial management, the computer comprising a data repository, the method comprising:
providing an interface for a user to establish a user account;
securely communicating user account information with a financial institution to establish an account;
coordinating account balance data between the financial institution and the data repository;
configuring the interface to provide the user access to account balance information;
configuring the interface to provide the user an opportunity to establish spending goals, wherein the spending goals are associated with the account balance; and
providing the user with feedback on progress toward achieving the spending goals.

22. A system for financial management, the system comprising:
a processor;
a user interface functioning via the processor;
a repository accessible by the processor;
a user account established via the user interface;
an account balance of available funds that tracks the deposit and withdrawal transactions of a financial institution account; and
means for a user to define goals, the goals stored in the repository for retrieval and comparison to the available funds.

23. The system of claim 22, wherein the processor is housed on a terminal.

24. The system of claim 23, wherein the terminal is selected from a group consisting of a personal computer, a minicomputer, a main frame computer, a microcomputer, a hand held device, and a telephonic device.

25. The system of claim 22, wherein the processor is housed on a server.

26. The system of claim 25, wherein the server is selected from a group consisting of a personal computer, a minicomputer, a microcomputer, and a main frame computer.

27. The system of claim 26, wherein the server is coupled to a network.

28. The system of claim 27, wherein the network is the Internet.

29. The system of claim 27, wherein the server is coupled to the network via a coupling.

30. The system of claim 29, wherein the coupling is selected from a group consisting of a wired connection, a wireless connection, and a fiber optic connection.

31. The system of claim 22, wherein the repository is housed on a server.

32. The system of claim 31, wherein the server is coupled to a network.

33. A computer program product comprising a computer usable medium having control logic stored therein for causing a computer to perform financial management calculations, the control logic comprising:
a first computer readable program code means to establish a user account for financial management;
a second computer readable program code means to maintain an account balance based on funds deposited and withdrawn from a financial institution account;
a third computer readable program code means to establish a spending goal that is tracked in coordination with the account balance; and
a fourth computer readable program code means for providing the user access to user account information.
